(19) United States
(12) Patent Application Publication
(10) Pub. No.: US 2010/0206464 A1
(43) Pub. Date: Aug. 19, 2010

(54) STEEL PLATE FOR REFRIGERATOR DOOR AND MANUFACTURING METHOD THEREOF

(75) Inventors: Dong-Soo Heo, Changwon City (KR); Jae-Woong Yun, Changwon City (KR); Kang-Ug Lee, Changwon City (KR); Sang-Ho Park, Changwon City (KR)

Correspondence Address: BIRCH STEWART KOLASCH & BIRCH, PO BOX 747, FALLS CHURCH, VA, 22040-0747, US

(73) Assignee: LG Electronics Inc, Seoul (KR)

(21) Appl. No.: 12/598,750

(22) PCT Filed: Mar. 31, 2008
(86) PCT No.: PCT/KR08/01809

§ 371 Date: Apr. 26, 2010

(30) Foreign Application Priority Data
May 4, 2007 (KR) 10-2007-0043635

(51) Int. Cl. B32B 38/10; F25D 23/02; B24B 1/00

(52) U.S. Cl. 156/153; 428/687; 451/54

(57) ABSTRACT

Provided are a steel plate for a refrigerator door and a method for manufacturing the steel plate. The steel plate includes a stainless steel plate provided on and forming an exterior of a refrigerator door with a vertical length of 1250 mm or more. The stainless steel plate surface is processed to form a finished texture oriented in a horizontal direction with respect to the refrigerator door. The method includes cutting a section from a rolled stainless steel plate base material corresponding in length to a length of a refrigerator door, rotating the cut section by a 90° angle, and surface processing through grinding a surface of the cut section in a direction perpendicular to a rolled direction thereof.

### TECHNICAL FIELD

The present disclosure relates to a steel plate for a refrigerator door and a manufacturing method thereof.

### BACKGROUND ART

In general, a refrigerator is a home appliance that employs cold air generated through a refrigeration cycle to maintain stored food items in refrigerated and frozen states. Due to recent changes in eating habits and tastes, various types of refrigerators are being developed.

That is, refrigerators now include top mount refrigerators in which the refrigeration and freezer compartments are partitioned so that the freezer compartment is stacked atop the refrigeration compartment, bottom freezer refrigerators in which the freezer compartment is provided at the bottom, and side-by-side refrigerators in which the refrigeration and freezer compartments are divided and disposed side-by-side.

In addition, these various types of refrigerators may include added features for the convenience of users, such as dispensers, home bars, and ice machines. Because a refrigerator has become a necessary appliance in the kitchen, more efforts are being made to improve refrigerator designs to better integrate the appliances with kitchen interiors.

Because refrigerator doors are the most prominently exposed portions of a refrigerator, there is a tendency to make their designs more outstanding through the use of customized colors, patterns, and designs. Recently, exteriors of refrigerator doors have been formed with stainless steel plates with a special finish and texture to appeal to buyers seeking a more refined look.

Bottom freezer type refrigerators usually have the refrigeration compartment at the top and the freezer compartment below. The refrigeration compartment is further divided into left and right compartments.

Included are refrigerator compartment doors that open pivotably forward from the main body to open and close the refrigeration compartment, and a freezer door that slides forward and rearward to open and close the freezer compartment.

The front of each door is manufactured of a stainless steel plate with an inherent polish and texture. When considering the overall height of the refrigerator, the refrigerator doors, which have a greater height than width, usually employ plates with a vertical length L of 1250 mm or less.

A manufacturing method of a stainless steel plate for a refrigerator according to the related art will be described below.

To manufacture a steel door of a refrigerator, a base material in the form of an aluminum plate of a predetermined thickness provided in a roll is first prepared.

Here, the width W of the base aluminum plate is 1250 mm or less, so that it can be used in a typical bottom freezer refrigerator for the refrigeration compartment doors that have a vertical length of 1250 mm or less.

Next, the base of the rolled aluminum plate is continuously surface treated. Here, when subjected to surface treating, the base adopts a surface texture in the polishing direction thereof—e.g., the unwinding direction of the roll.

The base material that has been surface treated is washed and dried to remove impurities, and then the base material removed of impurities is wound again in a roll, etc. and stored and shipped.

The re-rolled base material is then cut to a size corresponding to a refrigerator door by a cutting machine, completing the manufacturing process of the plate forming the exterior of the door.

However, there exist the following limitations in the related art.

When a base material of stainless steel is surface treated so that its surface texture is formed in a rolled direction, a length of the plate may be cut corresponding to the vertical length of a door, in order to form the exterior of the door.

Here, when the surficial grain of the door is formed in a longitudinal (vertical) direction, not only is the brightness of the finish reduced by the longitudinal texture, but an irregular reflection results.

To obviate this limitation, the direction of surficial texture on the door must be disposed in a transverse (lateral) direction. By using a roll of base material equal to the vertical length of the door and cutting the roll, a finished texture in a transverse direction can be obtained.

However, because rolls of stainless steel plates are restricted in width to a maximum of 1250 mm, if the vertical length L of a refrigerator door exceeds 1250 mm, a steel plate for a refrigerator door cannot be manufactured using methods according to the related art.

Of course, the width W of the stainless steel plate roll may be increased; however, this would be inconceivable in light of the substantial increase in production costs associated with reconfiguring the stainless steel manufacturing equipment.

### DISCLOSURE OF INVENTION

### Technical Problem

Embodiments provide a stainless steel plate for a refrigerator door provided on the front surface of a refrigerator door with a greater vertical length and a horizontally disposed surface texture, and to a manufacturing method thereof.

### Technical Solution

In one embodiment, a steel plate for a refrigerator door includes: a stainless steel plate provided on and forming an exterior of a refrigerator door with a vertical length of 1250 mm or more, the stainless steel plate surface processed to form a finished texture oriented in a horizontal direction with respect to the refrigerator door.

In another embodiment, a method for manufacturing a steel plate of a refrigerator door includes: cutting a section from a rolled stainless steel plate base material corresponding in length to a length of a refrigerator door; rotating the cut section by a 90° angle; and surface processing through grinding a surface of the cut section in a direction perpendicular to a rolled direction thereof.

### ADVANTAGEOUS EFFECTS

In disclosed embodiments, a stainless steel material base plate formed on the outside of a door is manufactured to have a finished surface textured in a transverse direction, to increase its brightness and reduce irregular reflectivity, and thus improve emotional quality.

Also, because a refrigerator with transverse surface-textured characteristics will appear larger, it will visually impress beholders as a large capacity refrigerator.

Although it was not previously possible to form steel plates for the doors of a side-by-side refrigerator exceeding 1700 mm in height using a standard sized 1250 mm wide stainless steel sheet roll, it is now possible to finish the plate surface in a transverse direction after cutting the sheet in the length of the door height.

Therefore, in side-by-side type refrigerators exceeding 1700 mm in height and in large capacity refrigerators, transverse-directional surface texturing is made possible, to achieve an improved finish and design.

### BRIEF DESCRIPTION OF THE DRAWINGS

The accompanying drawings are included to provide a further understanding of the present disclosure.

FIG. 1 is an external view of a side-by-side refrigerator employing a steel plate according to an embodiment of the present disclosure.

FIG. 2 is a flowchart of a method for manufacturing a steel plate for a refrigerator door according to an embodiment of the present disclosure.

FIG. 3 is a schematic conceptual view of a method for manufacturing a steel plate for a refrigerator door according to an embodiment of the present disclosure.

### BEST MODE FOR CARRYING OUT THE INVENTION

Reference will now be made in detail to the preferred embodiments of the present disclosure, examples of which are illustrated in the accompanying drawings.

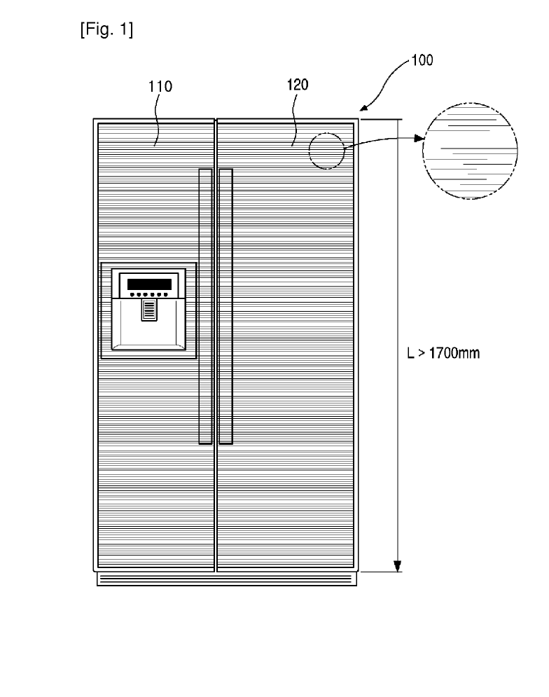

FIG. 1 is an external view of a side-by-side refrigerator employing a steel plate according to an embodiment of the present disclosure.

Referring to FIG. 1, the exterior shape of a refrigerator 100 according to the present embodiment is approximately hexahedral, is elongated in a vertical direction, and includes a main body 110 and doors 110 and 120.

The main body defines a storage space within that is divided into a freezer compartment on the left and a refrigeration compartment on the right. The front of the main body is openable.

The front of the open storage space of the main body has the doors 110 and 120 attached thereon. The pair of doors 110 and 120 is mounted such that each door respectively opens in a pivoting manner from the left and right sides at the front of the main body, to selectively open and close the freezer and refrigeration compartments by pivoting.

The vertical length L of the doors 110 and 120 may be approximately 1700 mm or more.

The surfaces of the doors 110 and 120 exposed to the outside are all made of stainless steel, and surface finished stainless steel plates are attached to the doors 110 and 120, to provide favorable texture and design.

The plates attached to the doors 110 and 120 may not only cover the front surfaces of the doors 110 and 120, but also the outer side edges thereof by being bent. If required, a separate plastic molding may be formed on the top surface and the bottom surface of the doors 110 and 120.

The outer surfaces of the doors 110 and 120 may be stainless steel plates that are ground and polished in a horizontal (transverse) direction to obtain a horizontally disposed finished texture, in order to increase brightness and reduce reflective irregularities.

Below, a method for manufacturing a stainless steel plate forming the exteriors of the doors 110 and 120 will be described.

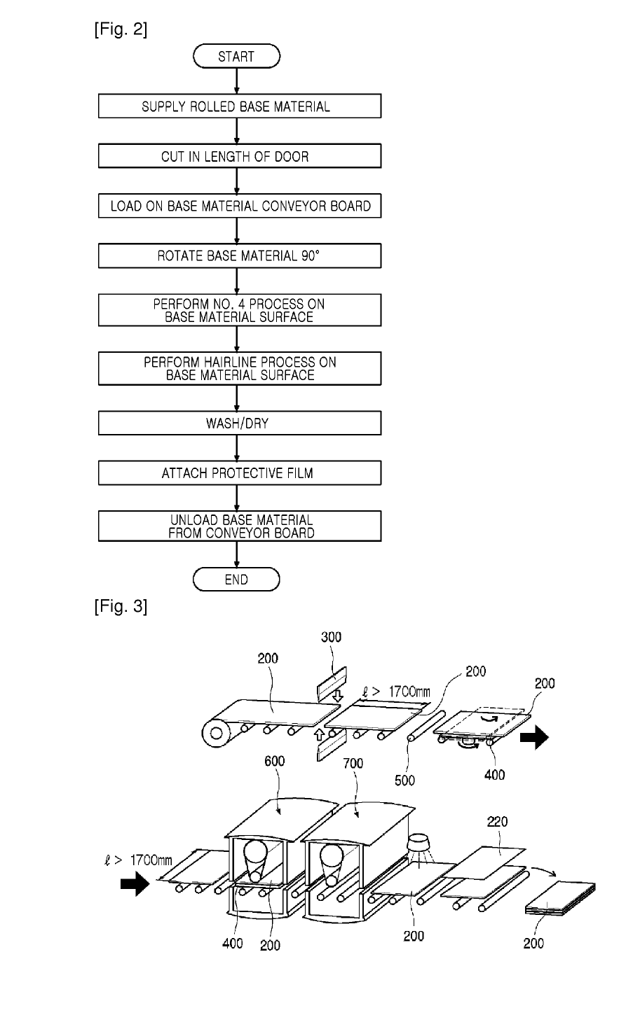

FIG. 2 is a flowchart of a method for manufacturing a steel plate for a refrigerator door according to an embodiment of the present disclosure, and FIG. 3 is a schematic conceptual view of a method for manufacturing a steel plate for a refrigerator door according to an embodiment of the present disclosure.

Referring to FIGS. 2 and 3, first, a stainless steel plate that is the base material 200 forming the exterior of the doors 110 and 120 is provided. Here, the stainless steel plate may be prepared for processing with a thickness between approximately 0.5 and 0.6 mm, by being wound in rolls after being rolled, in order to provide a continuous feed.

The width of the base material 200 is set based on the width of the door 110 and 120. When an appropriate width setting for the base material 200 is made, the roll of base material 200 is unwound and continuously supplied. Here, the fed direction of the base material 200 is the same as the direction in which it has been rolled.

The base material 200 is continuously supplied until a predetermined length has been fed, whereupon when the length of the supplied base material 200 corresponds to the vertical length of the doors 110 and 120, the material is cut by a vertically moving cutter 300.

This base material 200 is now a size that can form the exterior of the doors 110 and 120. That is, the base material 200 is formed in a size sufficient to cover the front and edge surfaces of the doors 110 and 120 when it is bent.

For example, in a side-by-side refrigerator such as that in FIG. 1, because the length of the doors 110 and 120 usually exceeds 1700 mm, the length (l) of the base material must also exceed 1700 mm, and must have even larger dimensions if it is to be bent to cover the perimeters of the doors 110 and 120.

The cut base material 200 is positioned on a conveyor board 400. The conveyor board 400 conveys the base material 200 and supports the base material 200 from below to securely convey it.

If the base material 200 were to be conveyed without being securely positioned on the conveyor board 400, there is the possibility of the base material 200 with a comparatively greater width and length sagging and structurally deforming. Such deformations can lead to defects in the shapes of the doors 110 and 120 or defects occurring during surface processing.

Accordingly, the base material may be continuously conveyed while placed on the conveyor board 400, or the base material 200 may be conveyed on a conveyor belt 500 instead of the conveyor board 400, according to requirements. Here, of course, the width of the conveyor belt 500 may be greater than the width of the base material 200 to prevent sagging of the base material 200.

The cut and conveyed base material 200 is rotated in an opposite (perpendicular) direction to the feeding or rolling direction of base material 200. That is, if the base material 200 is rotated by approximately 90°, the conveying thereof in the same conveyed direction may be resumed.

To rotate the base material, the conveying board 400 carrying the base material 200 may be rotated by 90°, or a suctioning device or other apparatus at the top of the base material 200 may be used to lift and turn the base material 90°.

When the rolling direction of the base material 200 becomes perpendicular to the disposed direction of the base material 200 through the rotation of the base material 200, the base material 200 is continuously conveyed with its length running perpendicular to the feeding direction.

While rotated at 90°, the base material 200 has its surface finished through continued surface processing, so that the formed processing pattern is disposed in the direction in which the base material 200 is conveyed.

That is, the surface texture of the base material 200 is formed in a direction perpendicular to the rolled direction of the base material 200 (or the lengthwise direction of the base material 200, so that the base material 200 has a surface textured in a transverse direction when the base material 200 is mounted on the doors 110 and 120.

With regards to the surface processing of the base material 200, the base material 200 is ground by a processing device 600 for implementing a No. 4 process. Here, if the particles of sandpaper used to grind the surface of the base material 200 is 150-180 Mesh, the high-speed rotation of the sandpaper presents an irregular pitch.

During the surface finishing of the base material 200, instead of a No. 4 process, No. 1 to No. 8 processes may be performed, in which case a transverse surface patterning may be formed on the surface of the base material 200.

The processing device 600 for performing the No. 4 process may, if needed, be either provided in-line in plurality to perform a plurality of No. 4 processes as the base material 200 is continuously conveyed, or provided singularly to move back and forth performing multiple processes.

Through such use of multiple processing devices or a single processing device performing multiple processes as the base material 200 is moved back and forth, an operator is afforded control to obtain a desired pitch, and can control the surface patterning of the base material 200 with pitch uniformity.

After the No. 4 process is completed, the base material 200 is continuously conveyed, and a hairline process is performed on the surface of the base material 200. For this, a processing device 700 that is disposed in-line with the processing device 600 that performs the No. 4 process uses a sandpaper grade adequate for performing a hairline patterning to continuously pattern the surface of the base material 200 in a transverse direction.

The hairline process may be omitted if not required, and a variety of textures may be formed on the surface of the base material 200 using not only the No. 4 process, but various combinations of the No. 1 to No. 8 processes. Here, of course, the base material 200 is continuously supplied to form transverse textured finishes on surfaces thereof.

When the surface processing of the base material 200 is completed, the base material 200 is continuously conveyed to be washed and dried. That is, because ground particles during surface processing remain on the surface of the base material 200, the surface of the base material 200 must be washed and dried. Here, the washing and drying of the base material 200 may be performed in-line.

When the washing and drying is completed, the base material 200 is continuously conveyed to adhere a protective film 220 thereon. The protective film 220 is for preventing damage to the surface treated portion, and may be the widely used polyvinyl chloride (PVC) or polyethyleneterphthalate (PET) films.

The adhering process of the protective film may also be performed continuously in-line, and the base material 200 on which the protective film is attached is stacked, stored, and transported to be attached when the doors 110 and 120 are formed.

1. A steel plate for a refrigerator door, comprising a stainless steel plate provided on and forming an exterior of a refrigerator door with a vertical length of 1250 mm or more, the stainless steel plate surface processed to form a finished texture oriented in a horizontal direction with respect to the refrigerator door.

2. The steel plate according to claim 1, wherein the refrigerator door is provided on a side-by-side type refrigerator.

3. The steel plate according to claim 1, wherein the stainless steel plate is surface processed with a No. 4 process or a hairline process to form the finished texture oriented in the horizontal direction with respect to the refrigerator door.

4. A method for manufacturing a steel plate of a refrigerator door, comprising:
cutting a section from a rolled stainless steel plate base material corresponding in length to a length of a refrigerator door;
rotating the cut section by a 90° angle; and
surface processing through grinding a surface of the cut section in a direction perpendicular to a rolled direction thereof.

5. The method according to claim 4, wherein the surface processing through grinding comprises performing a No. 4 grinding process on the surface of the cut section with a sandpaper of between 150 and 180 Mesh.

6. The method according to claim 5, further comprising performing a hairline process forming a continuous ground texture with a sandpaper having a predetermined particle size, after the performing of the No. 4 grinding process.

7. The method according to claim 4, further comprising:
washing and drying the surface processed section; and
adhering a protective film to the surface processed surface of the washed and dried section.

8. The method according to claim 7, wherein the rotating of the cut section by the 90° angle comprises:
positioning the cut section on a conveyor board that is rotatably configured; and
rotating the cut section by the 90° angle, wherein the cut section is continuously conveyed on the conveyor board until the adhering of the protective film is completed.

9. The method according to claim 7, wherein the rotating of the cut section by the 90° angle comprises:
conveying the cut section on a conveyor belt; and
rotating the cut section by the 90° angle, wherein the cut section is continuously conveyed on the conveyor belt until the adhering of the protective film is completed.

10. The method according to claim 7, wherein the protective film used in the adhering of the protective film on surface of the washed and dried section is a polyvinyl chloride film or a polyethyleneterphthalate film.
